(19) United States
(12) Patent Application Publication
(10) Pub. No.: US 2013/0300373 A1
(43) Pub. Date: Nov. 14, 2013

(54) Methods and Systems for Battery Management and Charger Control

(71) Applicants: Rene Vivanco-Sarabia, Johns Creek, GA (US); Douglas C. Magnuson, Milton, GA (US)

(72) Inventors: Rene Vivanco-Sarabia, Johns Creek, GA (US); Douglas C. Magnuson, Milton, GA (US)

(73) Assignee: EXIDE TECHNOLOGIES INC., Milton, GA (US)

(21) Appl. No.: 13/467,404

(22) Filed: May 9, 2012

(51) Int. Cl. H02J 7/00

(52) U.S. Cl. 320/134; 320/162; 320/150

(57) ABSTRACT

A battery system including a battery pack having a plurality of battery cells and a charger control circuit configured to receive unregulated power from a source and to provide regulated power to the battery pack. The battery system also includes a battery management system configured to individually monitor and control the plurality of battery cells and the charger control circuit.

### BACKGROUND

The present invention relates to battery management and charger control, and more specifically, to battery management and charger control methods and systems for use with lithium-ion batteries.

Lead acid batteries have long been used for a wide variety of applications. For example, in the telecom industry battery backup systems that use lead acid batteries are commonly used to provide backup power in case of power loss. Lead acid batteries are also commonly used to provide motive power to equipment such as lift trucks and the like. Advances in battery technology have led to batteries that have a higher charge density, faster rate of charge, and that are more environmentally friendly compared to lead acid batteries. One such advanced battery technology is lithium-ion batteries. Unfortunately, these advanced batteries can not be simply, or safely, exchanged for the lead acid batteries that are currently being used.

Due to the unique charging characteristics of lead acid batteries, the existing charging systems that are currently used for various lead acid batteries are relatively simple. Since lead acid batteries can tolerate changes in charging rate, standardized lead acid batteries can be used in various systems that require different voltages and currents. In contrast, lithium-ion batteries require precise control of the charging rate. Accordingly, in order to replace existing lead acid batteries with lithium-ion batteries a charger that is matched for use with the lithium-ion battery must be used to provide charge control. However, replacing the existing charging systems in the various applications that currently use lead acid batteries with chargers matched for use with lithium-ion batteries would be extremely costly.

Accordingly, what is needed is a lithium-ion battery system capable of being used with charging infrastructure currently used with lead acid batteries.

### SUMMARY

According to one embodiment, a battery system includes a battery pack having a plurality of battery cells and a charger control circuit configured to receive unregulated power from a source and to provide regulated power to the battery pack. The battery system also includes a battery management system configured to individually monitor and control the plurality of battery cells and the charger control circuit.

According to another embodiment, a method for charging a battery pack having a plurality of battery cells, the method includes receiving an unregulated power from a source and monitoring a voltage level of each of the plurality of battery cells. The method also includes determining if the voltage level of any of the plurality of battery cells exceeds a set-point voltage. Based on determining that the voltage level of one of the plurality of battery cells exceeds the set-point voltage, the method includes providing a regulated taper current to the plurality of battery cells to maintain the voltage of each of the plurality of battery cells. Based on determining that the voltage level of all of the plurality of battery cells are below the set-point voltage, the method includes providing a regulated charging current to the plurality of battery cells to increase the voltage of each of the plurality of battery cells.

According to another embodiment, a method for operating a battery system including a battery pack having a plurality of cells includes initializing the battery system by testing one or more functions of the battery system and one or more peripheral power assistance components. The method also includes determining if the battery system is in a charge state or a discharge state and in response to the battery system being in the charge state, providing a controllable charge to each of the plurality of cells in the battery pack and individually monitoring a charge level of each of the plurality of cells, a temperature of battery pack and a current draw of each of the plurality of cells. In response to the battery system being in the discharge state, the method includes individually monitoring the charge level of each of the plurality of cells, the temperature of battery pack and a current drawn from each of the plurality of cells. In response to determining that the temperature of the battery pack exceeds a threshold value, the method includes operating the battery system in a soft disable state, wherein during the soft disable state the battery system periodically checks the battery pack for one or more fault conditions. In response to detecting one or more severe fault conditions, the method includes operating the battery system in a panic state.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a block diagram of a lithium-ion battery system in accordance with an exemplary embodiment of the disclosure;

FIG. 2 illustrates a block diagram of a battery system in accordance with an exemplary embodiment of the disclosure;

FIG. 3 illustrates a block diagram of an uninterruptible power system in accordance with an exemplary embodiment of the disclosure

FIG. 4 flowchart of a method for charging a battery pack in accordance with an exemplary embodiment of the disclosure; and

FIG. 5 illustrates a state diagram of the operational modes of a battery system in accordance with an exemplary embodiment.

### DETAILED DESCRIPTION

Disclosed herein is a lithium-ion battery system capable of being used with charging infrastructure currently configured for use with lead acid batteries. The lithium-ion battery system includes battery management circuitry, charger control circuitry and a lithium-ion battery pack disposed in a single housing. The lithium-ion battery system is configured to replace existing lead acid battery systems that are designed for use with chargers. In addition, the lithium-ion battery system is configured to include a plurality of battery modules to provide a scalable controllable battery system.

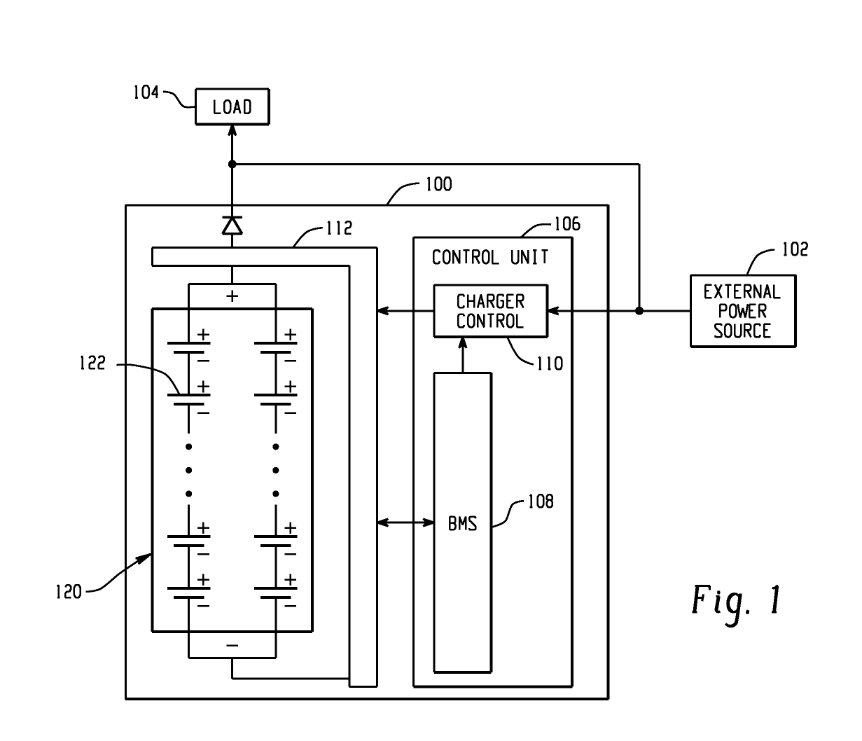

Turning now to FIG. 1, a block diagram of a lithium-ion battery system 100 in accordance with an exemplary embodiment of the disclosure is shown. The lithium-ion battery system 100 receives power from a source 102 and is configured to provide power to a load 104. In exemplary embodiments, the source 102 is an unregulated DC power source which provides power that may not have a constant current and/or voltage. In exemplary embodiments, the lithium-ion battery system 100 may be configured as a uninterruptible power system that provides power to the load 104 only when there is a disruption in energy supplied by the source 102. In other embodiments, the lithium-ion battery system 100 may be configured to be a primary source of power for the load 104 and may only be connected to the source 102 during charging.

In exemplary embodiments, the lithium-ion battery system 100 includes a control unit 106 and a battery pack 120. The control unit 106 includes a battery management system 108 and a charger control circuit 110. The charger control circuit 110 receives unregulated power from the source 102 and provides regulated power to the battery pack 120 through a connector 112. The connector 112 is connected to the battery management system 108, which is configured to selectively connect battery cells 122 of the battery pack 102 to the charge control circuit 110. In exemplary embodiments, the battery management system 108 is configured to ensure that the battery pack 120 is operating in safe operating conditions and to protect the battery pack 120 against over-current, over-voltage (during charging), under-voltage (during discharging), and over-temperature conditions.

In exemplary embodiments, the battery management system 108 is an electronic system which manages the battery pack 120 by monitoring both the state of charge and the state of health of the battery pack 120, and the battery cells 122 that it contains. The state of charge, or depth of discharge, is a measurement that indicates the charge level of the battery pack 120. The state of health is a measurement that indicates the overall condition of the battery pack 120. In exemplary embodiments, the state of health of the battery pack 120 is a percentage of remaining life of the battery pack. In exemplary embodiments, the battery management system 108 may use variables including, but not limited to, the maximum charge/discharge current, the energy delivered since last charge or charge cycle, the total energy delivered since first use, or the total operating time since first use to determine the state of charge and/or state of health of the battery pack 120.

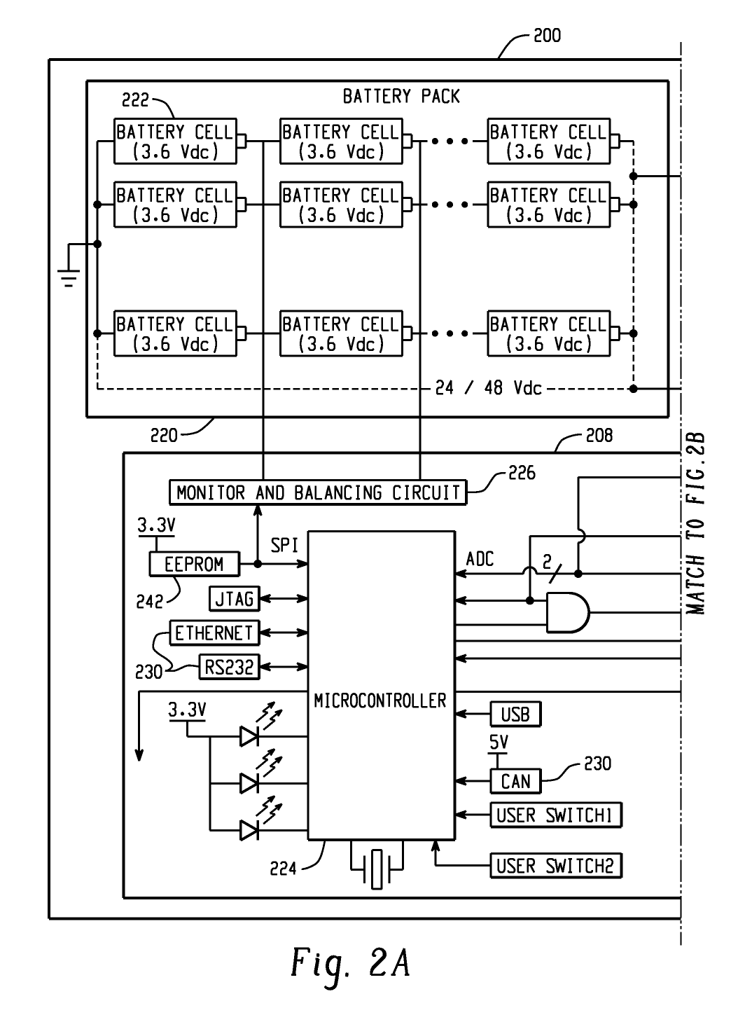

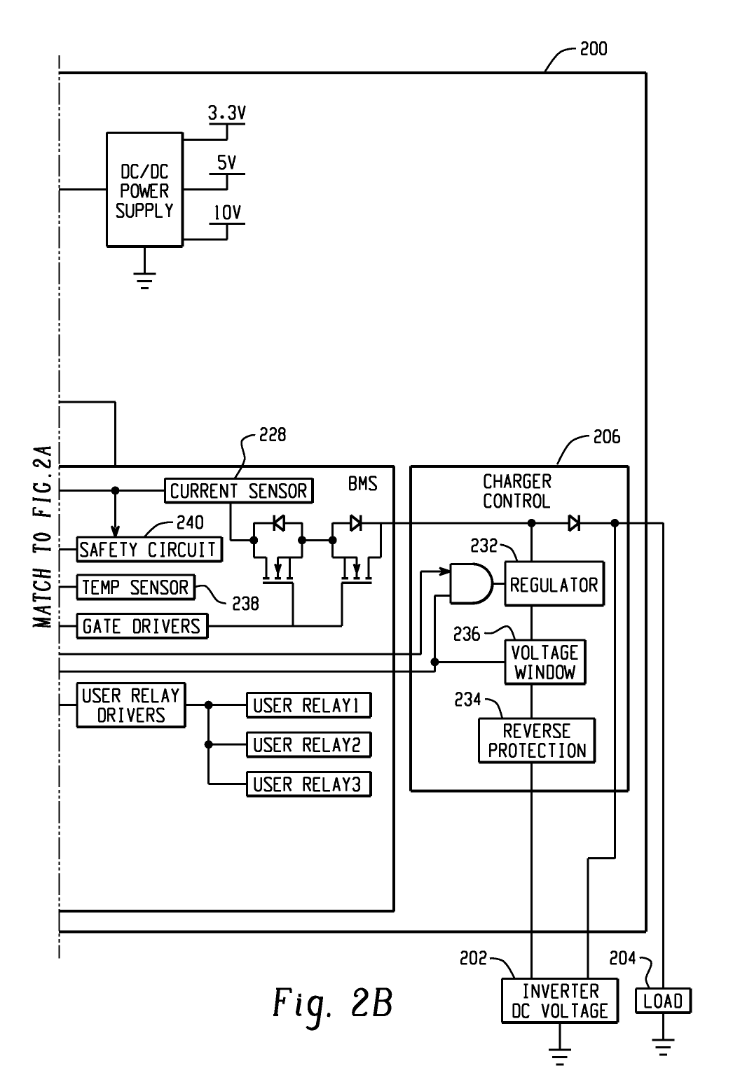

Referring now to FIG. 2, a block diagram of a battery system 200 in accordance with an exemplary embodiment of the disclosure is shown. In exemplary embodiments, the battery module 200 includes a charger control circuit 206 configured to receive power from a DC source 202 and to selectively provide power to a load 204 and a battery pack 220. The charger control circuit 206 is configured to regulate the voltage and current from the DC source 202 to provide an efficient way to charge and protect the battery pack 220. In exemplary embodiments, the charger control circuit 206 is configured to send and receive signals from a battery management system 208, which controls the operation of the charger control circuit 206.

In exemplary embodiments, the charger control circuit 206 includes reverse protection circuitry 234 which protects the charger control circuit 206 in the event that the voltage of the source 202 is improperly connected or becomes reversed. In addition, the charger control circuit 206 includes a voltage window circuit 236, which receives a voltage from the source 202 and determines whether the received voltage is between two threshold voltages. In exemplary embodiments, the voltage window circuit 236 provides a signal to the battery management system 208 that indicates the magnitude of the voltage received from the source 202. The charger control circuit 206 also includes a DC-DC converter 232, which receives an input voltage from the voltage window circuit 236 and control signals from the battery management system 208. In response to the control signals received from the battery management system 208, the DC-DC converter 232 generates an output signal with a regulated voltage, which can be provided to the battery pack 220.

In exemplary embodiments, the battery management system 208 includes a microcontroller 224, a current sensor 228, a temperature sensor 238, monitoring and balancing circuitry 226 and safety circuitry 240. The microcontroller 224 receives signals from the charger control circuit 206, the current sensor 228, the temperature sensor 238, the monitoring and balancing circuitry 226 and the safety circuitry 240 and responsively controls operation of the battery pack 220 and the charger control circuit 206. In exemplary embodiments, the battery pack 220 includes a plurality of cells 222 which can each be individually monitored and addressed by the microcontroller 224 though the monitoring and balancing circuitry 226. In exemplary embodiments, the battery management system 208 may also include one or more communications devices 230. For example, the communications devices 230 may include an Ethernet connection, a universal serial bus (USB) connection, an RS232 connection, a controller area network (CAN) bus connection, or the like. In exemplary embodiments, the CAN bus connection may be used to communicate with, and optionally control, one or more additional battery systems. The communications devices 230 can also be configured to provide remote access to the battery management system 208. In exemplary embodiments, the battery management system 208 includes a non-volatile memory 242, such as an EEPROM. The non-volatile memory 242 may be used to store fault logs, calibration values, variables and the like.

In exemplary embodiment, the microcontroller 224 receives a signal from the current sensor 238 indicative of the current being provided to, or drawn from, the battery pack 220 and signals from the monitoring and balancing circuitry 226 indicative of the voltage level of each cell 222 of the battery pack 220. Based on the voltage level of the cells 222 of the battery pack 220, the microcontroller 224 responsively provides a regulated current to each of the cells 222 of the battery pack 220. For example, if the all of the cells of the battery pack 220 have a voltage below a set-point voltage, the microcontroller 224, provides a regulated charging current to each of the cells 222 in an attempt to increase the voltage of the cells 220. In another example, once the voltage of one of the cells 222 of the battery pack 220 reaches the set-point voltage, the microcontroller 224 can provide a regulated taper current to the cells 222 to maintain the voltage level of the cells 222. In exemplary embodiments, the microcontroller 224 can adjust the current provided to the battery pack 220 by controlling the operation of the charger control circuit 206.

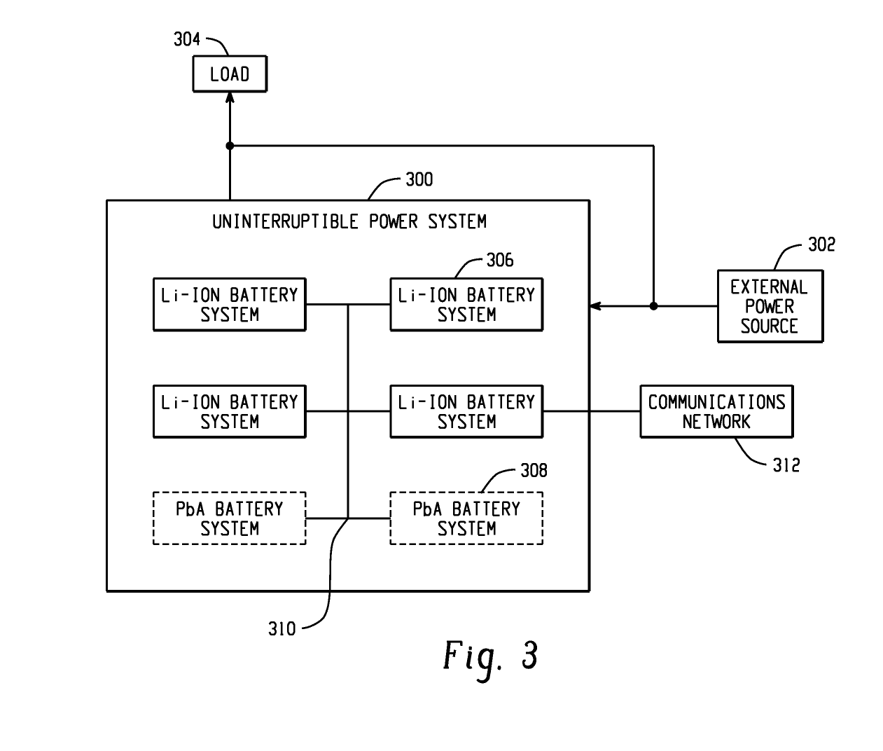

Referring now to FIG. 3, a block diagram of an uninterruptible power system 300 is shown. As illustrated the uninterruptible power system 300 is configured to receive power from a source 302 and provide and uninterrupted power supply to a load 304. The uninterruptible power system 300 includes a plurality of lithium-ion battery systems 306, such as those described in detail with reference to FIGS. 1 and 2. In addition, the uninterruptible power system 300 may include a plurality of lead acid battery systems 308. The plurality of lithium-ion battery systems 306 and lead acid battery systems 308 are configured to communicate with one another via a bus 310. In exemplary embodiments, one of the lithium-ion battery systems 306 can be configured to a primary or master lithium-ion battery system 306 that can control the operation of the other lithium-ion battery systems 306 and lead acid battery systems 308. The lithium-ion battery system 306 designated as the primary lithium-ion battery system 306 can also be configured to communicate with a communications network 312 to provide remote monitoring and control of the uninterruptible power system 300.

In exemplary embodiments, the uninterruptible power system 300 may include a plurality of battery systems that are configured to communicate with one another. In various applications the voltage required will impact the number of battery modules that are required by the lithium uninterruptible power system 300. Accordingly, the lithium uninterruptible power system 300 is designed to include a scalable number of battery systems, such that additional battery systems can be added to a system to provide increased capacity. In addition, the number of battery system in the uninterruptible power system 300 can be selected based on the characteristics of the source 302, such as the voltage or current level. In exemplary embodiments, lead acid in addition to lithium-ion. In exemplary embodiments, where one or more lead acid battery systems 308 are used, the lead acid battery systems can be a source of unregulated power which can be regulated by the primary lithium-ion battery system 306.

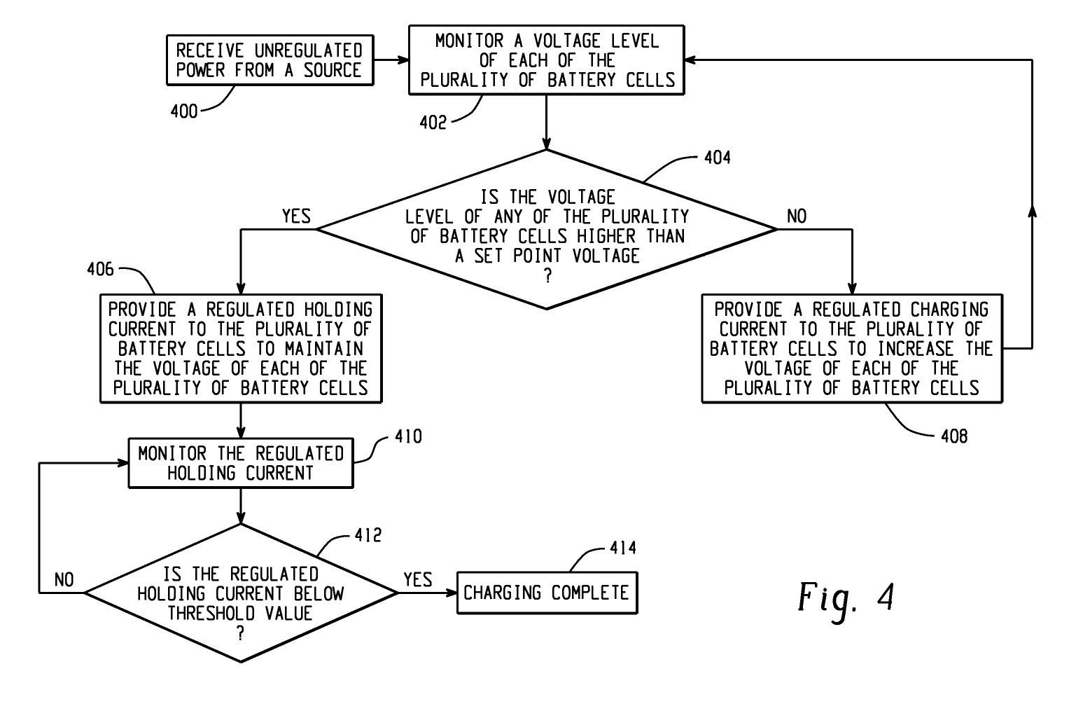

Referring now to FIG. 4, a flowchart illustrating a method for charging a battery pack in accordance with an exemplary embodiment is shown. As illustrated, the method includes receiving unregulated power from a source, as shown at block 400. As shown at block 402, the method also includes monitoring a voltage level of each of the plurality of battery cells in the battery pack. At decision block 404, the method includes determining if the voltage level of any of the plurality of battery cells exceeds a set-point voltage. In exemplary embodiments, the set-point voltage may be the desired voltage for each cell. Based on determining that the voltage level of one of the plurality of battery cells is at or above the set-point voltage, the method proceeds to block 406 and provides a regulated taper current to the plurality of battery cells to maintain the voltage of each of the plurality of battery cells. In exemplary embodiments, based on determining that the voltage level of at least one of the plurality of battery cells are at or above the set-point voltage, the method includes setting a voltage reading of the battery pack to a target voltage level. For example, in a battery system with a target voltage of 53.3V that includes thirteen battery cells with a set point voltage of 4.1 V, during charging once the voltage level of a single battery cell reaches 4.1 V, the voltage reading of the battery pack will be set to 53.3V.

Continuing with reference to FIG. 4, based on determining that the voltage level of all of the plurality of battery cells are below the set-point voltage, the method proceeds to block 408 and provides a regulated charging current to the plurality of battery cells to increase the voltage of each of the plurality of battery cells. As the regulated charging current is provided to the battery cells, the method continues to monitor the voltage level of each of the plurality of battery cells, as shown at block 402. As shown at block 410, the method also includes monitoring the regulated taper current provided to the plurality of battery cells. Next, as shown at decision block 412, the method includes determining if the regulated taper current is below a threshold value. In exemplary embodiments, the threshold value is a desired minimum current regulated taper current. If the regulated taper current is below a threshold value, the method proceeds to block 414 and the charging cycle is complete. If the regulated taper current is not below a threshold value, the method continues to monitor the regulated taper current, as shown at block 410.

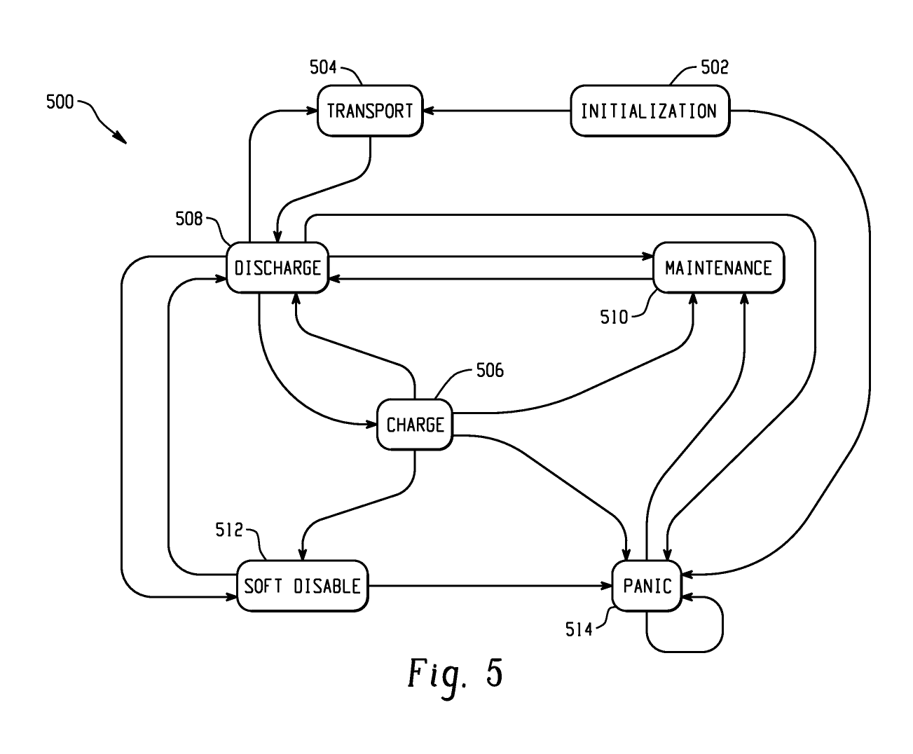

Referring now to FIG. 5, a state diagram 500 of the operational modes of a battery system in accordance with an exemplary embodiment is shown. As illustrated the operation of the battery system can be generally represented by the following seven states: initialization 502; transport 505; charge 506; discharge 508; maintenance 510; soft disable 512; and panic 514. During the initialization 502 state the battery system tests the functions that are required to ensure the integrity operation of the battery system and the peripheral power assistance components. In addition, the battery system performs initialization for microcontroller peripherals such as interrupt handler; interrupt priorities, I/O configuration and variable initialization. During the transport 505 state the battery system turns off the majority of its power as well as the microcontroller peripherals. The transport 505 state is designed for battery pack transportation in order to assure that the pack does not deliver power and communications with the battery management system are not available in this mode. The battery system enters the charge 506 state when the battery pack is below a specified state-of charge and is connected to a source. During the charge 506 state all peripherals are active and communications with the battery management system are available. While in the charge 506 state the battery management system provides a controllable charge to each of the plurality of cells in the battery pack and individually monitors a charge level of each of the plurality of cells, a temperature of battery pack and a current draw of each of the plurality of cells. During the discharge 508 state the battery system is fully operational and the battery management system is monitoring the operation of the battery system constantly. In addition, during the discharge 508 state communications with the battery management system are available and the battery system can discharge storage energy. While in the discharge 508 state the battery management system individually monitors a charge level of each of the plurality of cells, a temperature of battery pack and a current drawn from each of the plurality of cells.

The battery system will enter the soft disable 512 state upon detection of charger over temperature condition or battery pack over current during charge or discharge. During the soft disable 512 state the battery system periodically checks the battery pack for fault conditions. The battery system will enter the panic 514 state upon detection of severe fault condition such relay problem or battery pack damage. During the panic 514 state communications with the battery management system are still available. In exemplary embodiments, the battery system may save faults log in the non-volatile memory. The maintenance 510 state is designed for troubleshooting and its main purpose is to verify the operation of the battery pack, update firmware and flush history logs.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A battery system comprising:
a battery pack comprising a plurality of battery cells;
a charger control circuit configured to receive unregulated power from a source and to provide regulated power to the battery pack; and
a battery management system configured to individually monitor and control the plurality of battery cells and the charger control circuit.

2. The battery system of claim 1, wherein the battery management system comprises:
a current sensor;
a temperature sensor;
a monitoring and balancing circuitry;
a communications device;
a microcontroller in communication with the current sensor, the temperature sensor, the monitoring and balancing circuitry, the charger control circuitry and the communications device, wherein the microcontroller is configured to control the operation of the charger control circuit; and
wherein the microcontroller is further configured to communicate with one or more additional battery systems.

3. The battery system of claim 2, wherein the monitoring and balancing circuitry monitors the voltage of each of the plurality of battery cells.

4. The battery system of claim 1, wherein the charger control circuit comprises:
a reverse protection circuitry;
a voltage window circuitry; and
a DC-DC converter.

5. The battery system of claim 2, wherein the charger control circuit comprises:
a reverse protection circuitry;
a voltage window circuitry; and
a DC-DC converter;
wherein the microcontroller is configured to control an output voltage level of the DC-DC converter.

6. The battery system of claim 1, wherein the battery, the charger control circuit and the battery management system are disposed in a housing.

7. The battery system of claim 2, wherein the communications device of the battery management system is configured to communicate with one or more additional battery systems.

8. The battery system of claim 2, wherein the communications device of the battery management system is configured to provide remote access to the battery management system.

9. The battery system of claim 1, wherein one or more of the plurality of battery cells are lithium-ion.

10. A method for charging a battery pack comprising a plurality of battery cells, the method comprising:
receiving an unregulated power from a source;
monitoring a voltage level of each of the plurality of battery cells;
determining if the voltage level of any of the plurality of battery cells exceeds a set-point voltage;
based on determining that the voltage level of one of the plurality of battery cells exceeds the set-point voltage, providing a regulated taper current to the plurality of battery cells to maintain the voltage of each of the plurality of battery cells; and
based on determining that the voltage level of all of the plurality of battery cells are below the set-point voltage, providing a regulated charging current to the plurality of battery cells to increase the voltage of each of the plurality of battery cells.

11. The method of claim 10, wherein one or more of the plurality of battery cells are lithium-ion.

12. The method of claim 10, further comprising setting a voltage reading of the battery pack to a target voltage based on determining that the voltage level of one of the plurality of battery cells exceeds the set-point voltage.

13. The method of claim 10, further comprising:
monitoring the regulated taper current; and
in response to determining that the regulated taper current is below a threshold value no longer providing the regulated taper current to the plurality of battery cells.

14. The method of claim 13, further comprising:
monitoring a temperature of the battery pack;
determining if the temperature of the battery pack exceeds a maximum temperature;
based on determining that the temperature of the battery pack exceeds the maximum temperature, operating the battery pack in a soft disable mode.

15. A method for operating a battery system including a battery pack having a plurality of cells comprising:
initializing the battery system by testing one or more functions of the battery system and one or more peripheral power assistance components;
determining if the battery system is in a charge state or a discharge state;
in response to the battery system being in the charge state, providing a controllable charge to each of the plurality of cells in the battery pack and individually monitoring a charge level of each of the plurality of cells, a temperature of battery pack and a current draw of each of the plurality of cells;
in response to the battery system being in the discharge state, individually monitoring the charge level of each of the plurality of cells, the temperature of battery pack and a current drawn from each of the plurality of cells;
in response to determining that the temperature of the battery pack exceeds a threshold value, operating the battery system in a soft disable state, wherein during the soft disable state the battery system periodically checks the battery pack for one or more fault conditions; and
in response to detecting one or more severe fault conditions, operating the battery system in a panic state.

16. The method of claim 15, further comprising initializing one or more microcontroller peripherals including an interrupt handler, interrupt priorities, I/O configuration and variable initialization.

17. The method of claim 15, wherein the battery system enters the charge state when a charge of the battery pack is below a specified state-of charge and the battery pack is connected to a source.

18. The method of claim 15, wherein during the panic state the battery system prevents a current from being provide to or drawn from the plurality of cells.

19. The method of claim 15, further comprising logging the one or more fault conditions in a non-volatile memory.
